(19) United States
(12) Patent Application Publication
(10) Pub. No.: US 2003/0115081 A1
(43) Pub. Date: Jun. 19, 2003

(54) Service provider

(76) Inventor: Fuyuki Ohtomo, Tokyo (JP)

Correspondence Address: BRINKS HOFER GILSON & LIONE, P.O. BOX 10395, CHICAGO, IL, 60610, US

(21) Appl. No.: 10/290,095

(22) Filed: Nov. 7, 2002

(30) Foreign Application Priority Data
Nov. 15, 2001 (JP) 2001-349754

(51) Int. Cl. G06F 17/60

(52) U.S. Cl. 705/1

(57) ABSTRACT

When map-information distribution is demanded by a user who uses a navigation apparatus, a map-information transmitter determines whether or not the status of charging for the user is appropriate. When the charging status is determined as inappropriate, as in a case where the total amount of fees (the total of a map-information fee and a communication fee) that have been charged until now approach a maximum value that had been set by the user, the map-information transmitter reduces the data amount of map information that was

to be transmitted according to a predetermined service plan and transmits the reduced map information to the user.

### BACKGROUND OF THE INVENTION

1. Field of the Invention

The present invention relates to a service provider for distributing various kinds of information using a network such as the Internet or the like.

2. Description of the Related Art

Recently, content distribution services for distributing various kinds of information (content) using a network such as the Internet or the like have become available. In a case where the content distribution service is used, an information terminal apparatus used by each user and a server used by the provider of the content are interconnected by the network. Therefore, various kinds of content can be transmitted from the server or the like to the information terminal apparatus. For example, in a case where a map-information distribution service that has become available in recent years is used, a server installed in a predetermined information center or the like and a navigation apparatus mounted in a car of a user are interconnected by the Internet for distributing map information as the above-described content to the navigation apparatus.

Generally, the above-described content distribution service can be provided either on a chargeable basis or on a free-of-charge basis according to the type of content for distribution. For example, content including information that is highly necessary, such as the above-described map information, is often distributed on a chargeable basis. In such a case, a charge can be assessed according to the amount and details of the content, or the time required for distributing the content. The user pays a content fee to the provider of the content according to the charge. Further, since the user connects his/her own information terminal apparatus to the server of the content provider through the Internet or the like for communication, the user needs to pay a communication fee to a communication company or the like.

As has been described, in the case where the user receives the content distribution service on a chargeable basis, the user pays a content fee to the content provider and a communication fee to the communication company or the like. The user may want to understand and control the total of the content fee and the communication fee as the total amount of money required for receiving the content distribution service. In the past, however, each of the content fee and the communication fee has been separately charged to the user by the content provider and the communication company. Therefore, the user had difficulty in understanding and controlling the details of the charges for receiving the content distribution service.

Alternatively, in a case where the content is automatically distributed, it is difficult for the user to limit the communication time and the data amount of the content. Therefore, it is also difficult in this case for the user to understand and control the details of the charging for the content distribution service. For example, in the case of the above-described map-information distribution service, the map information may be automatically distributed to the user according to the movement of a car of the user. Therefore, the user has difficulty in limiting the communication time and the details of the distributed map information. Accordingly, it is difficult for the user to understand and control the details of the charges.

As has been described, when a user uses a content distribution service or the like over a communication link, the user had difficulty in understanding and controlling the details of the charges.

### BRIEF SUMMARY OF THE INVENTION

Accordingly, it is an object of the present invention to provide a service provider for which the user can understand and control the details of the charges for a service provided over a communication link.

A service provider according to the present invention stores information about a maximum value of charging for each user in a maximum-value storing unit. Further, the service provider modifies the details of the information for distribution based on the maximum-value information and provides the service for distributing the information to the user through a service-providing unit. Thus, when providing the service, the service provider modifies the details of the information according to the maximum-value charge information for each user. Therefore, the service providing is controlled so that the amount of the charges for each user is substantially lower than the maximum value. Accordingly, the details of the charges for the service, which is provided to the users over a communication link, can be easily understood and controlled.

Preferably, the above-described maximum-value information is set according to an operating instruction transmitted by the user. Subsequently, the user can freely set the maximum charge value.

The service provider may further comprise a service-plan generating unit for generating a service plan so that the details of the information for distribution can be modified based on the maximum-value information. Preferably, the service-providing unit provides the service according to the service plan, which is generated by the service-plan generating unit. Thus, the service provided to each user can be controlled according to the service plan, which is generated according to the maximum-value information for each user. Accordingly, the service is provided so that the charge amount is substantially lower than the maximum charge value for each user.

Preferably, a plurality of different candidate plans for distributing information are prepared. The service-plan generating unit preferably may select one of the candidate plans according to the maximum-value information for generating a service plan appropriate for the user. Thus, the service plan can be easily generated by selecting one of the plurality of candidate plans according to the maximum-value information.

Preferably, the service-providing unit selects the type of information which is distributed by the service based on the maximum-value information. For example, the amount (the data amount) of image information and of text information can be different from each other. That is to say, the data amount of information can differ according to the type thereof. Therefore, by selecting the type of information based on the maximum-value information, the service-providing unit can easily modify the details of the service.

Preferably, the service-providing unit selects the type of information which is distributed by the service based on the service plan. As described above, the amount (the data amount) of information differs according to the type thereof. Therefore, by selecting the type of the information based on the service plan, the service-providing unit can easily modify the details of the service.

Preferably, the service-providing unit obtains charging information for the provided service, determines whether or not the status of charging for the provided service is appropriate, and modifies the details of the service to be provided according to this determination. For example, when the actual charging status does not match the charging status expected from the maximum value which had been set by the user, the details of the service to be provided may be modified for reducing the cost. Thus, by modifying the details of the service to be provided according to whether or not the charging status is appropriate, the service-providing unit can reliably provide the service, which corresponds to the maximum charge value which had been set by the user.

Preferably, the service-providing unit sets an admissible limit for charging in consideration of the maximum-value information and a period subject to the charging. Then, the service-providing unit may preferably determine the charging status as inappropriate when charging is performed over the admissible limit and modify the details of the service to be provided. Thus, the admissible limit is determined in consideration of the maximum-value information and the period which is subject to the charging, for determining whether or not the charging status is appropriate. Subsequently, it becomes possible to clearly determine whether or not the charging status is appropriate at any time within the period which is subject to the charging. Accordingly, the user is protected from receiving too much service in the early part of the charge period. If the user had received too much service, the amount of charging would reach the maximum value and the user would not be able to receive service in the later part of the charge period. However, because of the modification, which is performed by the service-providing unit, the user can constantly receive service over the charge period.

When charging is performed in a predetermined period, the service-providing unit preferably may modify the details of the service to be provided in consideration of the amount of time that passes in the predetermined period which is subject to the charging. For example, suppose charging was performed over a month and the actual amount of the charge exceeded the amount of charge expected from the maximum value in the beginning of the month (for example, within ten days). When the user did not receive service from the middle to the end of the month, the charging status might return to the appropriate state. Therefore, if the charging status were determined to be inappropriate at the beginning of the month, it may not be necessary to modify the details of the service to be provided at once. Conversely, if the charging status were determined to be inappropriate at the end of the month, it would be necessary to modify the details of the service to be provided. Since the service-providing unit modifies the details of the service to be provided in consideration of the time that has passed in the predetermined period, the details of the service to be provided are not modified unnecessarily. Accordingly, the service-providing unit can provide a service of uniform quality to the user.

Preferably, the service provider further comprises a charging-information generation-and-update unit that generates the charging information for the user, monitors the status of service providing performed by the service-providing unit, and updates the charging information. Accordingly, the charging status of each user can be clearly understood.

Preferably, charging includes a first fee for the provided service and a second fee for communication performed for the provided service. Accordingly, the total amount of the fees which are required for the provided service can be easily understood and controlled.

Further, the second fee may be a fixed fee for unlimited communication. Although the second fee is fixed, the first fee may change according to the provided service. Subsequently, the total amount of the first and second fees, which are required for the provided service, is charged. Therefore, the total amount of the fees can be clearly understood and controlled.

Further, the first fee may be a fixed fee that does not correspond to the amount of the information provided by the service. Although the first fee is fixed, the second fee may change according to the provided service. Subsequently, the total amount of the first and second fees, which are required for the provided service, is charged. Therefore, the total amount of the fees can be clearly understood and controlled.

Further, the second fee may be determined according to the amount of the information provided by the service for which the first fee is charged. For example, when the communication fee is determined according to the amount of information for transmission and reception instead of the communication time, as in a case where packet switching data communication service or the like is used, the second fee is determined according to the amount of the information, which is distributed by the service. Accordingly, the total amount of the fees which are required for the provided service can be clearly understood and controlled.

Preferably, the service provider further comprises a notification unit that determines whether or not the charge for the provided service exceeds a reference value that is set according to the maximum-value information based on the charging information, which is generated by the charging-information generation-and-update unit. When the charge exceeds the reference value, the notification unit may transmit a notification to the user for notifying the user of the fact that the charge exceeds the reference value. Accordingly, the user can easily and clearly understand that the charge for the provided service approaches the maximum value which had been set by the user.

Preferably, the service-providing unit continues providing the service when the user agrees to pay more than the maximum value upon receiving the notification, which is transmitted from the notification unit. When the user does not agree to pay more than the maximum value, the service-providing unit preferably may stop providing the service. Accordingly, the user can freely select whether he/she agrees to pay more than the maximum value and keeps receiving the service, or he/she stops receiving the service.

### BRIEF DESCRIPTION OF SEVERAL VIEWS OF THE DRAWINGS

FIG. 1 illustrates the configuration of a map-information distribution system according to an embodiment of the present invention;

FIG. 2 illustrates the general configuration of a navigation apparatus;

FIG. 3 illustrates the general configuration of a map-information distribution server;

FIG. 4 illustrates the details of charging for providing a map-information distribution service;

FIG. 5 illustrates typical data stored in a communication-price database;

FIG. 6 is a flowchart illustrating the operation performed by the map-information distribution system for setting a service plan;

FIG. 7 illustrates typical details of the service plan;

FIG. 8 is a flowchart illustrating the operation performed by the map-information distribution system for distributing map information;

FIG. 9 illustrates a typical method for determining the status of charging for a user;

FIG. 10 illustrates a typical screen display for notifying the user of the charging status;

FIG. 11 illustrates the details of charging in a case where a content fee is fixed;

FIG. 12 illustrates the details of charging in a case where a communication fee is fixed for receiving unlimited communication service;

FIG. 13 illustrates typical data stored in the communication-price database in a case where the communication fee is determined according to the data amount;

FIG. 14A illustrates a modified method for determining the charging status; and

FIG. 14B illustrates another modified method for determining the charging status.

### DETAILED DESCRIPTION OF THE INVENTION

A map-information distribution system according to an embodiment of the present invention will now be described with reference to the drawings.

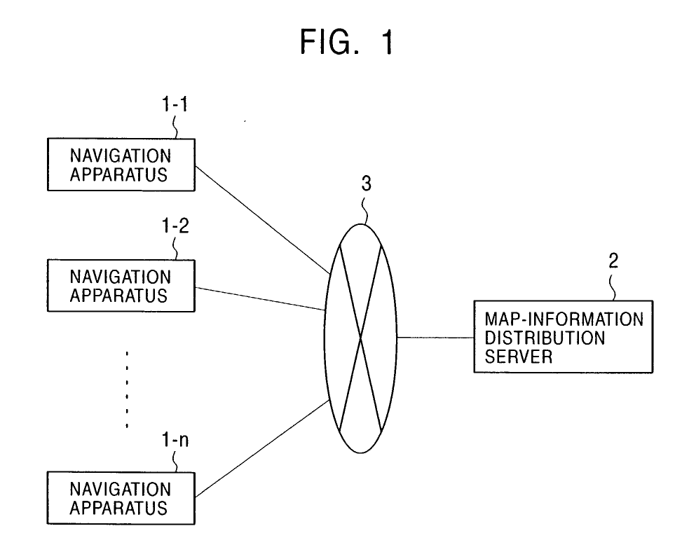

FIG. 1 illustrates the configuration of the map-information distribution system. The map-information distribution system includes navigation apparatuses 1-1, 1-2, . . . and 1-n and a map-information distribution server 2 that are interconnected by a predetermined network 3. Examples of the network 3 include various communication networks such as a general telephone network, a mobile-telephone network, and the Internet.

Each of the navigation apparatuses 1-1, 1-2, . . . and 1-n which is mounted in a car of a user, obtains map information from the map-information distribution server 2 through the network 3. Then, each of the navigation apparatuses performs a navigation process using the obtained map information. The navigation process includes displaying the map information, which is for the vicinity of the user's car, searching for a route, route guidance, and so forth. The navigation apparatuses and the network 3 are interconnected by, for example, a mobile phone (not shown). When new map information is needed because, for example, the user's car is moving, the navigation apparatus, which is mounted on the user's car, requests the map-information distribution server 2 to distribute new map information.

The map-information distribution server 2, which is installed in a predetermined information center or the like, offers map-information distribution service to the navigation apparatuses 1-1, 1-2, . . . and 1-n through the network 3.

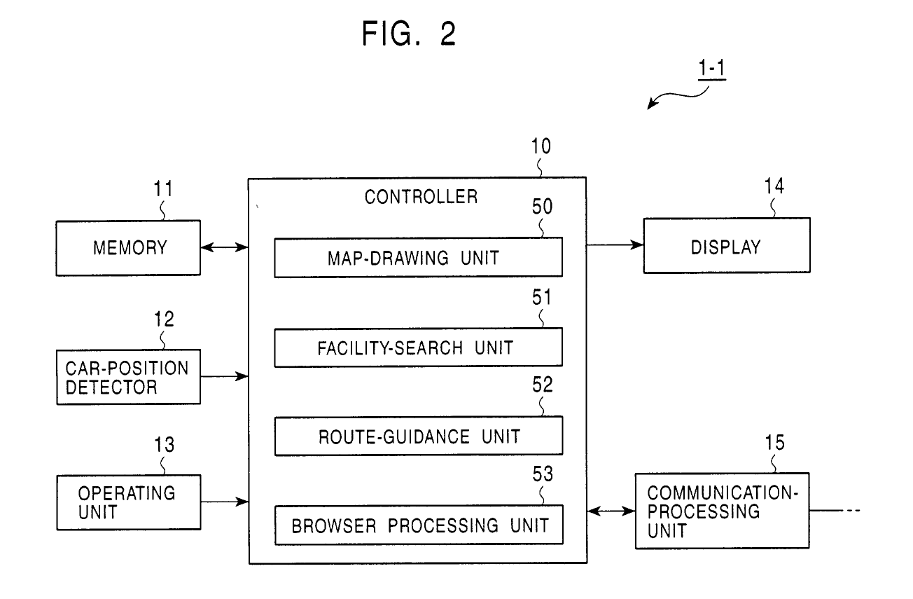

The configuration of the navigation apparatus 1-1 will now be described with reference to FIG. 2. The navigation apparatus 1-1 includes a controller 10, a memory 11, a car-position detector 12, an operating unit 13, a display 14, and a communication-processing unit 15. The configuration of the navigation apparatuses 1-2 to 1-n is the same as that of the navigation apparatus 1-1.

The controller 10 controls the overall operations of the navigation apparatus 1-1. The operations include the navigation process such as displaying the map information for the area surrounding the user's car, searching for a route, route guidance, and so forth. The operations further include receiving the map information by connecting with the map-information distribution server 2 through the network 3. The controller 10 includes a map-drawing unit 50, a facility-search unit 51, a route-guidance unit 52, and a browser processing unit 53.

The map-drawing unit 50 generates map-information data for producing the display of the map information for the area surrounding the user's car, using the map information which is transmitted from the map-information distribution server 2 and stored in the memory 11.

The facility-search unit 51 searches for information (such as address, name, and phone number) about various types of facilities (such as a convenience store) using the map information which is stored in the memory 11. The facility-search unit 51 performs the above-described search according to an instruction from the user.

The route-guidance unit 52 searches for a route that connects a predetermined destination identified by the user (for example, the address of a facility that is searched for by the facility-search unit 51) to the current position of the user's car. Further, the route-guidance unit 52 performs route guidance so that the user's car travels along the found route.

The browser processing unit 53 generates drawing data for producing a web-page display on the display 14 based on the data which is transmitted from the map-information distribution server 2. Further, when various types of data are entered according to the web page, the browser processing unit 53 transmits the entered data to the map-information distribution server 2.

The memory 11 stores the map information or the like which is transmitted from the map-information distribution server 2. The car-position detector 12, which includes a GPS receiver, a direction sensor, a distance sensor, and so forth, detects the position of the user's car (the latitude and longitude) and provides the detection result to the controller 10.

The operating unit 13, which includes various operating keys such as cursor-movement keys for up-and-down and left-to-right movements and a numeric keypad, provides a signal corresponding to the user's operation to the controller 10.

The display 14 produces a display of the map of an area around the user's car based on drawing data transmitted from the controller 10.

The communication-processing unit 15 performs processing procedures so that the controller 10 can perform data communication with the map-information distribution server 2 through the network 3.

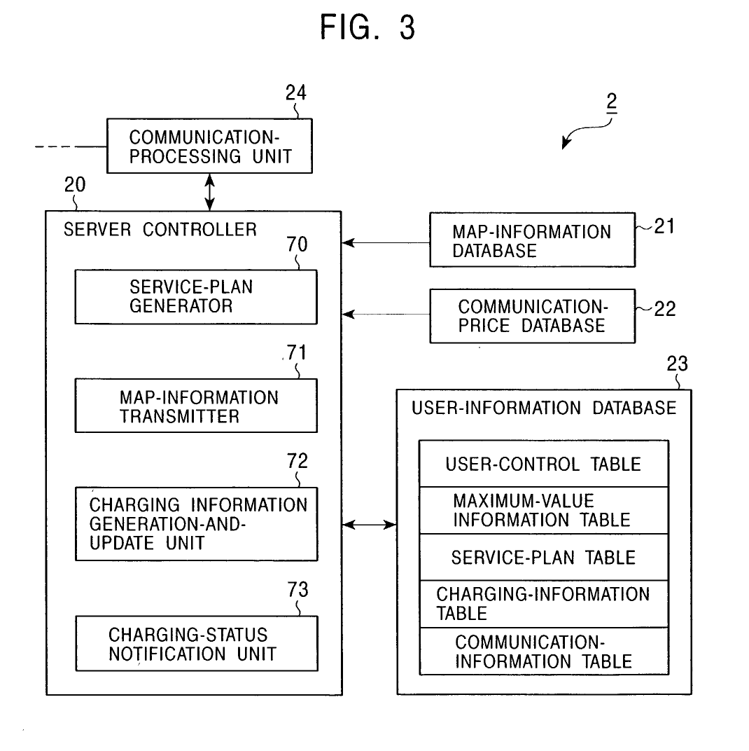

FIG. 3 illustrates the general configuration of the map-information distribution server 2. The map-information distribution server 2 includes a server controller 20, a map-information database 21, a communication-price database 22, a user-information database 23, and a communication-processing unit 24.

The server controller 20 includes a service-plan generator 70, a map-information transmitter 7-1, a charging-information generation-and-update unit 72, and a charging-status notification unit 73. The server controller 20 controls the overall operation of the map-information distribution server 2 for transmitting map information to the navigation apparatus 1-1 or the like according to a distribution demand transmitted from the navigation apparatus 1-1 or the like.

The service-plan generator 70 generates a service plan showing the details of the map-information distribution service based on the maximum value of charging that is determined by the user. The details of the map-information distribution service will be described later.

The map-information transmitter 71 transmits the map information to the navigation apparatus 1-1 or the like. The map-information transmitter 71 according to this embodiment controls the amount and details of data of the map information which is transmitted to the user, so that the charge for the user does not exceed a predetermined maximum value that had been determined by the user. More specifically, the map-information transmitter 71 obtains charging information that had been generated and stored in the user-information database 23 by the charging-information generation-and-update unit 72. Further, the map-information transmitter 71 determines whether or not the status of charging is appropriate based on the charging information and controls the amount and details of the data of the map information for distribution.

The charging-information generation-and-update unit 72 generates the charging information, which shows the details of the charge for providing the map-information distribution service to the user. Then, the charging-information generation-and-update unit 72 stores the charging information in the user-information database 23 and updates the details of the charging information as required.

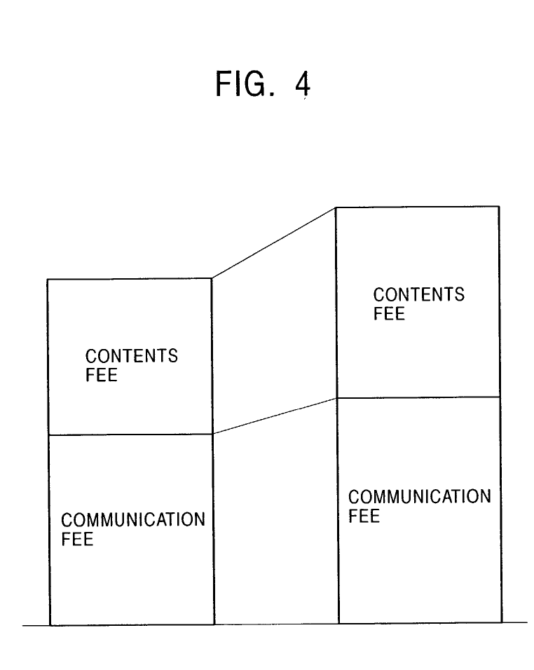

FIG. 4 illustrates the details of charging for providing the map-information distribution service to the user. The amount of charging is determined by a content fee (hereinafter referred to as a first fee) and a communication fee (hereinafter referred to as a second fee). The first fee is determined according to the type of the map information (the details of the type will be described later), the amount of the data, and so forth. The second fee is determined according to an amount that is paid by the user to a communication company or the like for communication that was performed between the navigation apparatus 1-1 or the like and the map-information distribution server 2 through the network 3. The first fee and the second fee are increased as the service is provided. Thus, by generating and updating the charging information, which includes the information about the first and second fees, it becomes possible to clearly understand and control the charging status of each user. Further, each user can easily understand and control the total fee for the provided service.

The charging-status notification unit 73 determines whether or not the charge amount exceeds a predetermined reference value that is determined according to the maximum value of charging (for example, 90 percent of the maximum value) based on the charging information, which is generated and stored in the user-information database 23 by the charging-information generation-and-update unit 72. When the charge amount exceeds the predetermined reference value, the charging-status notification unit 73 notifies the user of the fact that the charge amount exceeds the reference value. More specifically, the charging-status notification unit 73a transmits a message indicating that the charge amount approaches the maximum value to the navigation apparatus 1-1 or the like. The message is displayed on the display 14 of the navigation apparatus 1-1 or the like for notifying the user of the charging status.

The map-information database 21 stores the map information which is required for performing the navigation process, including the displaying of map-information, searching for a route, route guidance, and so forth.

The communication-price database 22 stores data on communication fees determined by various communication companies that might be used by the user for connecting the navigation apparatus 1-1 or the like to the network 3 using a mobile phone or the like.

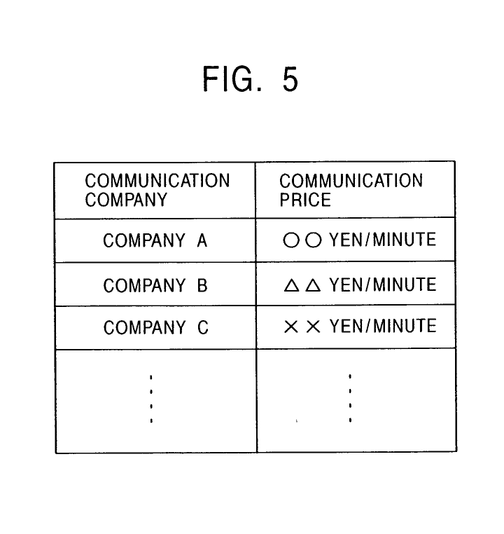

FIG. 5 illustrates typical data stored in the communication-price database 22. The communication-price database 22 stores data indicating communication fees (◯◯ yen/minute or the like) that are determined by communication companies such as A, B, C, and so forth. A communication fee that has to be paid by the user to the communication company can be calculated as described below. First, one of the communication prices, which is determined by the communication company used by the user, is read out from the communication-price database 22. Then, this communication price is multiplied by the amount of time the user communicates.

Turning back to FIG. 3, the user-information database 23 stores various types of information about the user who receives the map-information distribution service using the navigation apparatus 1-1 or the like.

More specifically, the user-information database 23 includes a user-control table including information for controlling the user, such as the name of the user, the identification number of the user, the details of the communication company used by the user, the number of hours the user receives the service for the month, and so forth.

Further, the user-information database 23 includes a maximum-value information table including maximum-value information indicating the maximum value of the charge, which is determined by the user (for example, 8,000 yen/month). Further, the user-information database 23 includes a service-plan table including information indicating the service plan of the user. As has been described, the service plan is generated by the service-plan generator 70 based on the maximum value of the charge.

Further, the user-information database 23 includes a charging-information table including the charging information for the user. As has been described, the charging information is generated and updated by the charging-information generation-and-update unit 72.

Further, the user-information database 23 includes a communication-information table including communication information indicating the number of hours the user communicates. The communication information is generated by the charging-information generation-and-update unit 72. The communication-processing unit 24 performs processing as required so that the server controller 20 can perform data communication with the navigation apparatus 1-1 or the like through the network 3.

The above-described map-information distribution server 2 corresponds to the service provider of the present invention. Further, the user-information database 23 corresponds to the maximum-value storing unit of the present invention and the service-plan generator 70 corresponds to the service-plan generator of the present invention. Further, the map-information transmitter 71 corresponds to the service provider unit, the charging-information generation-and-update unit 72 corresponds to the charging-information generation-and-update unit of the present invention, and the charging-status notification unit 73 corresponds to the notification unit of the present invention.

Now, the operation of the map-information distribution system according to an embodiment of the present invention will now be described.

(1) Operation for Setting the Service Plan

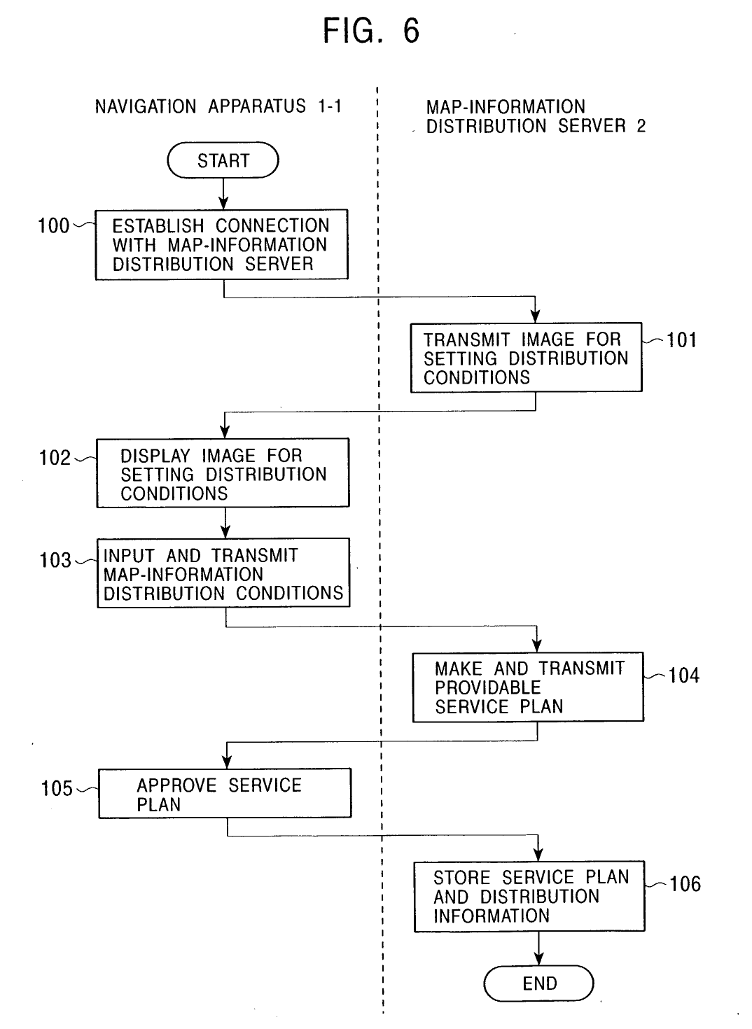

FIG. 6 is a flowchart illustrating the operation performed by the map-information distribution system for setting the service plan. The flowchart illustrates a case where a user who owns the navigation apparatus 1-1 inputs conditions for the map-information distribution, and a service plan is generated according to the input conditions.

First, the URL (Uniform Resource Locator) of the map-information distribution server 2 is determined by the operating unit 13 of the navigation apparatus 1-1. Then, a predetermined procedure is performed by the browser processing unit 53 of the controller 10, and the navigation apparatus 1-1 and the map-information distribution server 2 are interconnected through the network 3 (Step 100).

The server controller 20 of the map-information distribution server 2 transmits data required for producing an image display for setting the conditions for performing the map-information distribution (an image for setting distribution conditions) to the navigation apparatus 1-1 (Step 101).

The browser processing unit 53 of the navigation apparatus 1-1 displays the image for setting distribution conditions on the display 14 based on the data transmitted from the map-information distribution server 2 (Step 102). When this image is displayed, the user can select the distribution conditions such as:

(1) “maximum-value information” indicating the maximum value of the total fee (the sum of the content fee and the communication fee), which is required for receiving the map-information distribution service;

(2) “communication time” indicating roughly the expected time the user receives the map-information distribution service; and

(3) “communication company's name” for connection to the map-information distribution server 2.

Thus, according to the embodiment of the present invention, the user can freely set the maximum value of the charge and the communication company.

When the user selects the distribution conditions by using the operating unit 13, the browser processing unit 53 transmits the input distribution conditions to the map-information distribution server 2 (Step 103).

Upon receiving the distribution conditions, the service-plan generator 70 of the map-information distribution server 2 generates the service plan showing the details of the service that can be provided to the user in consideration of the received distribution conditions (the maximum-value information, the communication time, the communication company's name, and so forth). Then, the service-plan generator 70 transmits the service plan to the navigation apparatus 1-1 (Step 104).

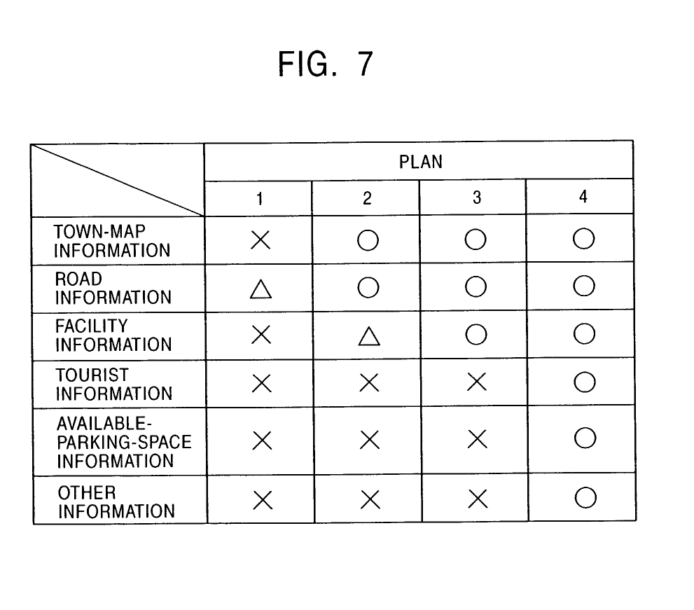

FIG. 7 shows a typical service plan. The map information, which is distributed by the map-information distribution system according to the embodiment, includes:

a. “town-map information” that is data used for producing a display of a town-map image,

b. “road information” that is data used for performing route guidance,

c. “facility information” that is data used for displaying the locations of various types of facilities such as a convenience store and searching for the facilities,

d. “tourist information” that is data on vacation locations, a scenic area, and so forth,

e. “available parking-space information” that is data on available parking space, and

f. “other information” that is various types of data that are not included in the above-described groups a to e.

Both the content fee and the communication fee are nearly proportionate to the amount of the map-information data. More specifically, as the amount of the map-information data increases, the content fee and the communication fee increase. Conversely, as the amount of the map-information data decreases, the content fee and the communication fee decrease.

A communication fee per unit time can be calculated by the maximum-value information and the time the user communicates to the map-information distribution server 2. When the amount of a communication fee, which is spent per unit time by the user, is high, a greater amount of map-information data is provided to the user than in a case where the amount of communication fee is low. Therefore, a service plan set for a user with a higher communication fee per unit time provides greater kinds of data to the user than in a case of a user with a lower communication fee per unit time. For a user with a higher communication fee per unit time, a service plan that can provide many kinds of data to the user is set. However, for a user with a lower communication fee per unit time, a service plan that provides fewer kinds of data than in the above-described case is set. Thus, the amount of map-information data provided to the users can be adjusted. As has been described, a service plan can be set according to the maximum value of charge for each user. Further, providing service to the user can be controlled according to the service plan. Therefore, the service, whose communication fee does not exceed the maximum value of charge, can be easily provided to each user.

More specifically, according to plan 1 shown in FIG. 7, the map information provided to a user includes road information only. Since the road information is only about highways (indicated by Δ) and the small amount of map-information data is distributed from the map-information distribution server 2 to the navigation apparatus 1-1 at one time, the total fee is lowered. However, according to plan 4, all kinds of data are distributed to the user. Since a large amount of map-information data is distributed from the map-information distribution server 2 to the navigation apparatus 1-1 at one time, the total fee is increased.

For example, suppose a user A sets the maximum-value information as “8,000 yen” and the communication time as “twenty hours”. The communication fee per hour of user A is calculated as 400 yen/hour. Further, suppose a user B sets the maximum-value information as “5,000 yen” and the communication time as “twenty hours”. The communication fee per hour of user B is calculated as 250 yen/hour. In such a case, a plan that can provide many kinds of data (for example, plan 4 shown in FIG. 7) is set for user A, and a plan that provides fewer kinds of data (for example, plan 3 shown in FIG. 7) than the plan set for user A is set for user B.

Thus, a service plan can be generated easily by having prepared a plurality of candidate plans, each of which provides information different from another, and by selecting one of the plans according to the maximum-value information or the like. However, the four plans in FIG. 7 are shown as examples. Therefore, many other plans having different kinds of data than in the above-described case may be prepared, and each user may generate his/her own plan according to the distribution conditions of the user.

When a service plan is generated in the above-described manner, the service-plan generator 70 of the map-information distribution server 2 transmits the service plan to the navigation apparatus 1-1. The browser processing unit 53 of the navigation apparatus 1-1 displays the details of the service plan based on the data transmitted from the map-information distribution server 2. When the user approves the details of the service plan, the browser processing unit 53 notifies the map-information distribution server 2 of the approval (Step 105).

Upon receiving the approval notice, the service-plan generator 70 of the map-information distribution server 2 stores the generated service plan and the distribution conditions such as the maximum-value information or the like in the user-information database 23 (Step 106).

(2) Operation for Distributing Map Information

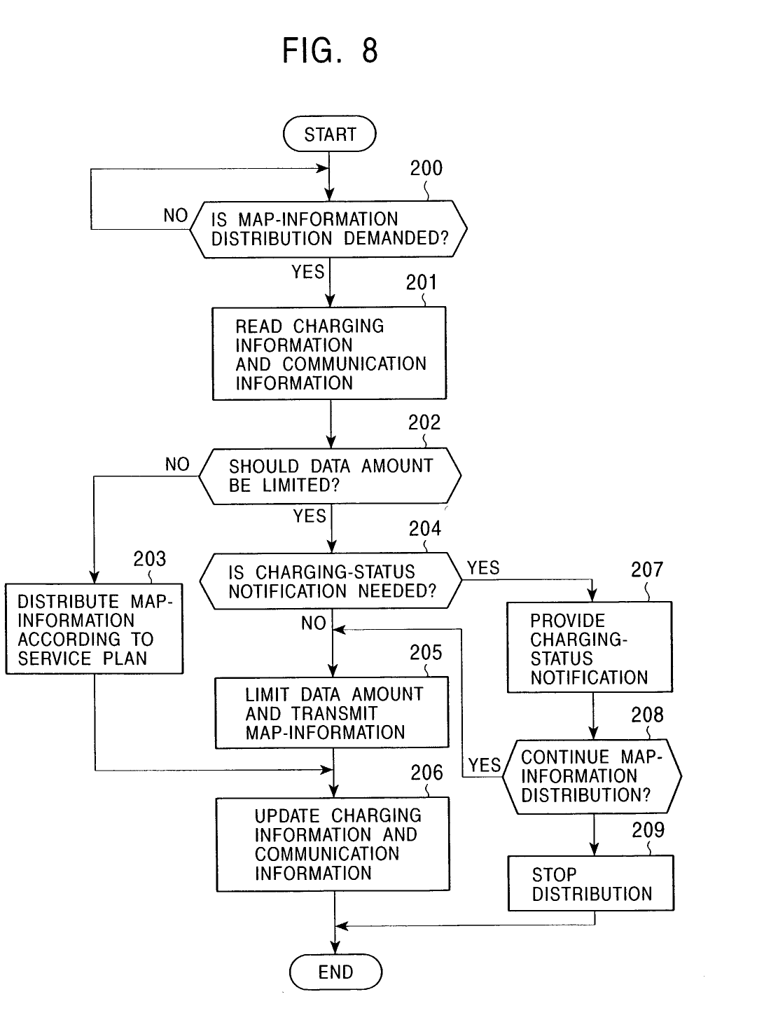

FIG. 8 is a flowchart illustrating steps performed by the map-information distribution system for distributing map information to the user. More specifically, the drawing illustrates the details of operation performed by the map-information distribution server 2.

The map-information transmitter 71 of the server controller 20 determines whether or not a map-information distribution request was transmitted from the navigation apparatus 1-1 or the like (Step 200). If the map-information transmitter 71 determines that no map-information distribution request was transmitted, the determination is performed again at Step 200.

When the map-information transmitter 71 determines a map-information distribution request has been transmitted at Step 200, the map-information transmitter 71 determines the user using the navigation apparatus (for example, the navigation apparatus 1-1) which transmitted the request, and reads the charging information and communication information of that user from the user-information database 23 (Step 201).

Then, the map-information transmitter 71 determines the charging status of the user based on the charging information and determines whether or not the amount of map-information data distributed to the navigation apparatus 1-1 should be limited (Step 202).

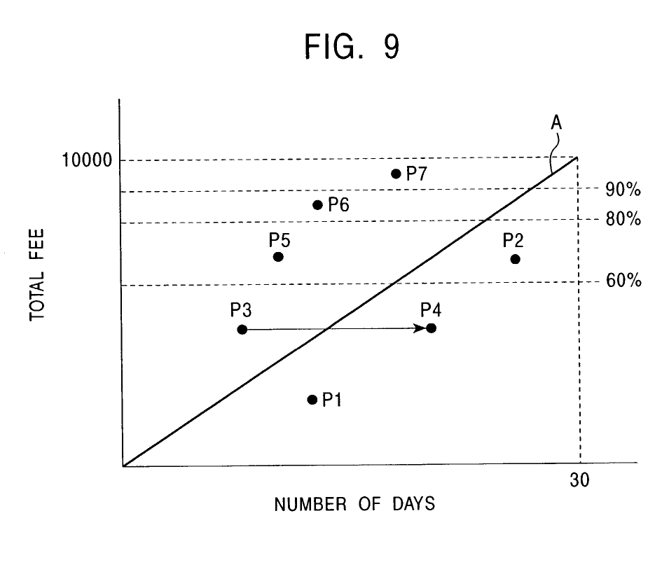

FIG. 9 illustrates a typical method for determining the status of charging for the user. In the drawing, the horizontal axis corresponds to the number of days and the vertical axis corresponds to the total fee. Further, line A is provided according to the maximum value, which is set by the user, for determining the charging status. The user sets his/her maximum value of the total fee per month as 10,000 yen. Here, the number of days of this month is thirty, for example. In this case, the user can receive map-information distribution until the total fee reaches the maximum value, that is, 10,000 yen. Therefore, if the assumption is made that the total fee increases in proportion to the number of days, the appearance of line A becomes as that shown in FIG. 9.

In such a case, on the current date, the map-information transmitter 71 determines whether or not the total fee, which is charged to the user, exceeds an expected total fee obtained by line A. If the total fee on some date is less than the expected total fee, as indicated by points P1 and P2 in FIG. 9, the charging status is determined as appropriate. In such a case, the map-information transmitter 71 transmits map information without limiting the data amount of the map information. That is to say, according to this embodiment, if a point indicating the total fee on the current date is under line A, the charging status for the user is determined to be admissible. Thus, the charging status for the user is determined to be admissible or not.

However, if the total fee charged to the user exceeds the expected total fee indicated by line A, the map-information transmitter 71 determines how much the total fee charged to the user increases and approaches the maximum value. According to the result, the map-information transmitter 71 limits the amount of map-information data for distribution.

More specifically, the map-information transmitter 71 determines the total fee as a percentage of the maximum value as one of (1) less than 60%, (2) 60% or more and less than 80%, (3) 80% or more and less than 90%, and (4) 90% or more.

Point P3 in FIG. 9 indicates that the total fee exceeds the expected total fee even though the current date is near the beginning of the month. However, if the total fee as a percentage of the maximum value is less than 60%, the map-information transmitter 71 distributes map information without limiting the data amount of the map information. This is because, even though the total fee exceeds the expected total fee at the beginning of the month, if the user does not receive any more map information for some time or if the user receives only a little more map information before the end of the month, the total fee might be less than the expected total fee as shown by point P4 in FIG. 9. In such a case, the data should not be limited. Thus, by determining whether or not the details of service should be changed in consideration of the number of days that have passed in a charge period, the details of service are not changed more than necessary. Therefore, it becomes possible to provide service of uniform quality to the user.

Further, as shown by point P5 in FIG. 9, if the total fee as a percentage of the maximum value is 60% or more and less than 80%, the map-information transmitter 71 reduces the data amount of the map information for distribution. In this case, the data amount is reduced by reducing part of the map information, and the type of the map information for distribution is not changed. For example, if the user receives three types of information, that is, town-map information, road information, and facility information, information that is relatively unnecessary in the facility information (for example, information about banks, museums, and so forth) is omitted. However, more necessary information (for example, information about convenience stores, gas stations, and so forth) is distributed. Further, for reducing part of the road information, information about roads designated by the prefecture and information about roads designated by the city may be omitted as relatively unnecessary information. However, information about roads designated by the government such as highways is distributed to the user.

Further, as shown by point P6 in FIG. 9, if the total fee as a percentage of the maximum value is 80% or more and less than 90%, the map-information transmitter 71 further reduces the data amount of the map information for distribution. In such a case, the data amount is reduced by reducing part of the map information as in the case where the total fee as a percentage of the maximum value is 60% or more and less than 80%. However, the type of the map information for distribution also is changed to reduce the data amount. For example, if the user receives four types of information, that is, town-map information, road information, facility information, and tourist information, the tourist information is omitted as relatively unnecessary information. However, other necessary information, that is, the town-map information, the road information, and the facility information are distributed.

Further, as shown by point P7 in FIG. 9, if the total fee as a percentage of the maximum value is 90% or more, the map-information transmitter 71 further reduces the data amount of the map information for distribution. In such a case, more data is reduced than in the case where the total fee as a percentage of the maximum value is 80% or more and less than 90%. For example, if the user usually receives four types of information, that is, town-map information, road information, facility information, and tourist information, information only about roads is distributed to the user as necessary information. Also, part of the information about roads is further reduced to reduce the data amount. Further, the charging-status notification unit 73 notifies the user of the charging status for the user. The details of the notification will be described later.

As has been described, the actual charging status for the user is determined as appropriate or not based on a charging status that is expected in view of the maximum value, which had been set by the user. Then, according to the determination result, the details of the service provided to the user are changed. Thus, it becomes possible to provide the service to the user, in accordance with the maximum value, which had been set by the user.

If the determination result shows that the data amount of the map information for distribution should not be limited, the map-information transmitter 71 determines that the data amount should not be limited at Step 202 and distributes the map information to the user, without limiting the data amount thereof, according to the service plan, which had been set by the user of the navigation apparatus 1-1 at Step 203.

Conversely, if the determination result shows that the data amount of the map information for distribution should be limited, the map-information transmitter 71 determines that the data amount should be limited at Step 202. Then, the charging-status notification unit 73 determines whether or not it should notify the user of the charging status at Step 204.

More specifically, the charging-status notification unit 73 uses 90% of the total fee, which had been set by the user, as a reference value as in the case illustrated by FIG. 9. When the total fee charged to the user on the current date exceeds the reference value, the charging-status notification unit 73 determines that it should notify the user of the charging status. However, in the last few days at the end of the month, if the total fee is less than the expected total fee, which is indicated by line A, it is determined that there is no need to notify the user of the charging status even though the total fee exceeds the reference value.

After determining that there is no need to notify the user of the charging status at Step 204, the map-information transmitter 71 reduces the data amount of the map information designated by the service plan, which had been set by the user of the navigation apparatus 1-1, and distributes the reduced map information to the user at Step 205. The details of a method for limiting the data amount of the map information for distribution were described above. That is to say, the data amount can be limited by reducing some types of the map information for distribution, for example. Thus, by selecting the type of the map information, the details of the service can be easily changed.

When the map-information transmitter 71 performs the processing at Step 203 or Step 205, the map-information is distributed to the user. Then, the charging-information generation-and-update unit 72 calculates the total fee (the content fee and the communication fee) which is charged to the user, based on the details of the map information distributed to the user and the communication time required for distributing the map information. Further, the charging-information generation-and-update unit 72 updates the charging information and the communication information, which are stored in the user-information database 23 at Step 206.

After determining that the user should be notified of the charging status at Step 204, the charging-status notification unit 73 transmits the charging status to the navigation apparatus 1-1 at Step 207.

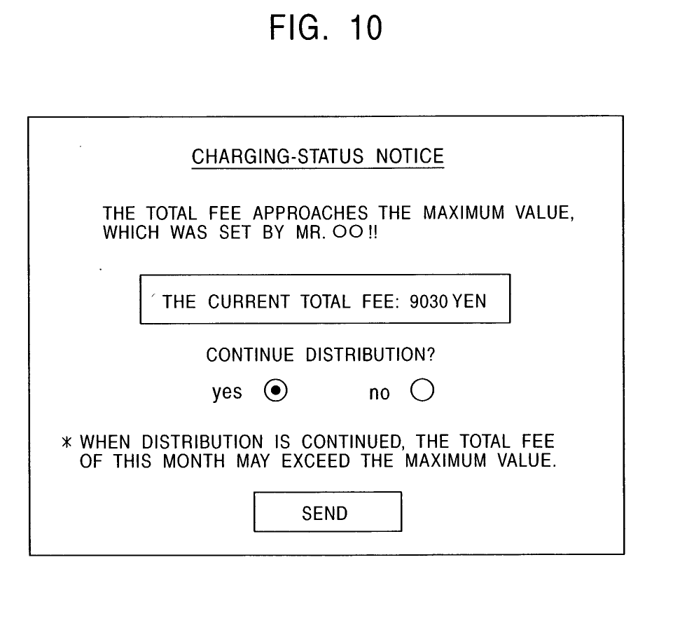

FIG. 10 illustrates a typical screen display for notifying the user of the charging status. The charging status, which is provided by the charging-status notification unit 73, includes information such as:

(1) the total fee on the current date,

(2) whether the total fee approaches the maximum value which had been set by the user,

(3) the choice of whether or not the user wishes to keep receiving the map-information distribution, and

(4) a notice that the total fee may exceed the maximum value if the map-information distribution is continued.

Incidentally, this screen display is displayed on the display 14 of the navigation apparatus 1-1. The user chooses either “yes” or “no” in the notification screen display by using the operating unit 13 and presses a “send” button, thereby sending information to the map-information distribution server 2 about whether or not the user wishes to continue receiving the map-information. Because such a notification screen display is provided, the user can easily and clearly understand that the total fee charged for the service which the user has received approaches the maximum value which had been set by the user. If the user agrees to pay more than the maximum value which had been set by the user, the map-information distribution server 2 continues providing the service to user. Otherwise, the map-information distribution server 2 stops providing the service to the user. Therefore, the user can freely select whether he/she agrees to pay more than the maximum value to continue receiving the service or he/she stops receiving the service.

Then, the charging-status notification unit 73 determines whether or not the user wishes to continue keep receiving the map-information distribution at Step 208, based on the details of the information transmitted from the navigation apparatus 1-1. When the charging-status notification unit 73 determines that the user wishes to continue receiving the map-information distribution at Step 208, the charging-status notification unit 73 transmits an instruction to distribute the map-information to the map-information transmitter 71. Then, the map-information transmitter 71 further reduces the data amount of the map-information and distributes the map information to the user at Step 205.

When the charging-status notification unit 73 determines that the user wishes to stop receiving the map-information distribution at Step 208, the charging-status notification unit 73 transmits an instruction to stop distributing the map-information to the map-information transmitter 71. Then, the map-information transmitter 71 stops distributing the map-information at Step 209.

Thus, the map-information distribution system according to this embodiment can set a service plan whose details are modified according to information about the maximum value of the charge, which had been set by the user. Subsequently, the map-information distribution system can provide service to the user according to the service plan. Further, the service providing is controlled so that the total fees charged to the users are substantially lower than the maximum values which had been set by the users. Accordingly, the details of charging for the service, which is provided to the users by communication, can be easily understood and controlled.

The present invention is not limited to the above-described embodiment, but can be modified in various ways without departing from the spirit and scope of the present invention. For example, in the above-described embodiment, a predetermined notification is provided to the user when the total fee as a percentage of the maximum value set by the user is 90% or more. However, the difference between an expected charging status calculated from line A in FIG. 9 and the actual charging status may be obtained as required. If the difference is large, the predetermined notification may be provided to the user.

More specifically, a fee per hour spent by the user may be monitored and if the fee is far larger than a fee per hour that is expected from the maximum value of the total fee, which had been set by the user, and the communication time (for example, when the fee spent by the user is two times as much as the expected fee or more), a notification may be provided to the user for notifying the user of the above-described fact. For example, if some user had set his/her maximum value of total fee as 8,000 yen and communication time for a month as 20 hours, an expected fee per hour is 400 yen. When the user starts receiving the service and an actual fee per an hour is calculated as 800 yen or more, the charging-status notification unit 73 provides a notification to the user for notifying the user of the fact that the actual fee per hour considerably exceeds the expected fee.

Alternatively, a total fee charged to the user at the end of a month may be estimated based on the actual fee per hour, and a notification of the estimated value may be provided to the user. For example, if the communication time is 14 hours and the total fee is 7,000 yen on June 7th, the communication time per day is 2 hours (=14 hours/7 days) and the fee per hour is 500 yen (=7,000 yen/14 hours). Subsequently, the estimated value of, the total fee (indicated by reference character Y) which is charged to the user at the end of a month is calculated as below. It should be noted that June has thirty days.

Y=30×2×500=30,000 yen

However, if the maximum value of the total fee set by the user was 10,000 yen, the estimated value of the total fee which is expected to be charged to the user at the end of June considerably exceeds 10,000 yen, that is, the maximum value of the total fee. In such a case, the charging-status notification unit 73 may provide a notification as a caution to the user that the estimated value of the total fee will become 30,000 yen at the end of June if the user continues receiving the service at the current pace. Otherwise, the charging-status notification unit 73 may transmit a notification indicating that the user may need to modify the service plan of the user.

In the above-described embodiment, when the total fee as a percentage of the maximum value is 90% or more, the predetermined notification is provided to the user. In response, the user selects whether or not he/she will continue receiving the service. However, a different notification may be transmitted to the user, that is, a notification indicating that the user needs to modify the details of the service plan. The modification includes resetting the maximum charge value and the communication time.

Further, in the above-described embodiment, the navigation apparatus 1-1 or the like which receives information (the map information) connects to the map-information distribution server 2, which transmits the map information as required. However, the map-information distribution server 2 may automatically connect to the navigation apparatus 1-1 or the like and perform the distribution.

Further, in the above-described embodiment, the content fee for the map-information distribution, that is, the first fee for the provided service, is charged according to the data amount and details of the map information which are provided to the user. However, the content fee may be fixed (or may not be charged) irrespective of the data amount of the map information which is provided to the user.

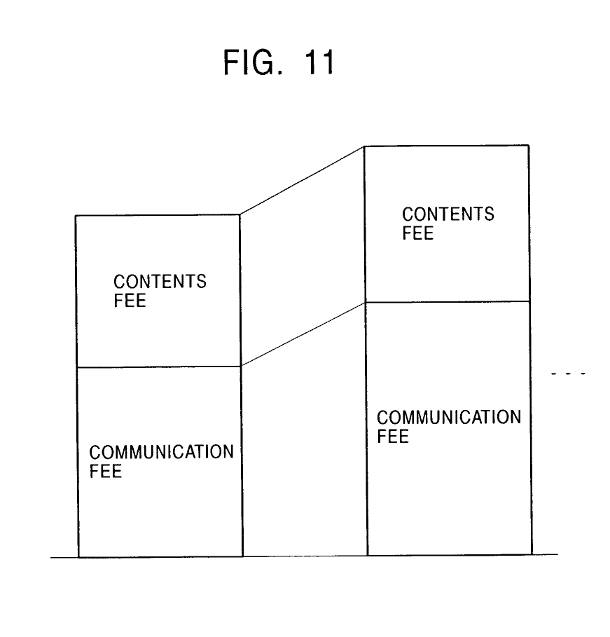

FIG. 11 illustrates the charging in a case where the content fee is fixed, and the amount of the total fee changes according to the communication fee. Therefore, the total fee can be controlled by controlling the communication fee by changing the data amount and details of the map information for distribution. Accordingly, the total fee can be clearly understood and controlled in the case where the content fee is fixed.

In the above-described embodiment, the communication fee (the second fee) which is charged for communication performed by the user is changed. However, the present invention can be used in a case where unlimited communication is performed, that is to say, a case where the communication fee is fixed.

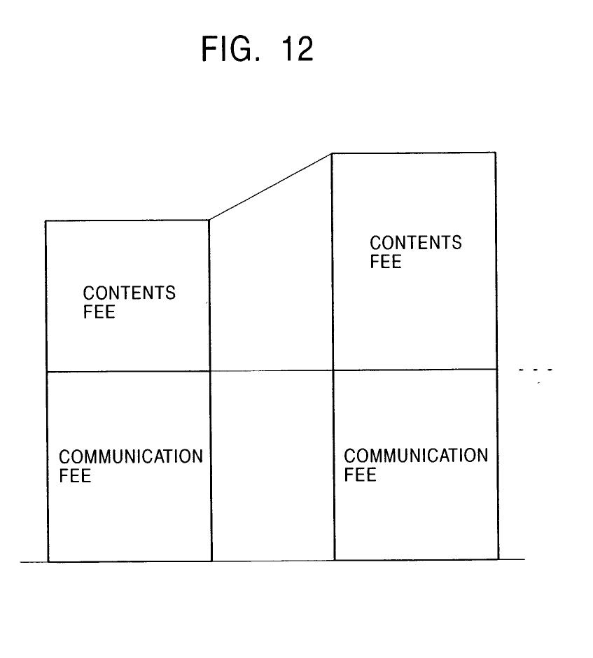

FIG. 12 illustrates the charging in the case where the communication fee is fixed for receiving unlimited communication service, and the total fee is changed according to the content fee. Therefore, the control fee can be controlled by changing the data amount and details of the map information for distribution. Accordingly, the total fee can be clearly understood and controlled in the case where the communication fee is fixed.

In the above-described embodiment, the communication fee is calculated according to the communication time. However, the present invention can be used in a case where the communication fee is calculated according to the data amount (the information amount) provided by the service, for which the content fee is charged. That is to say, the present invention can be used in a case where a packet switching data communication service or the like is used.

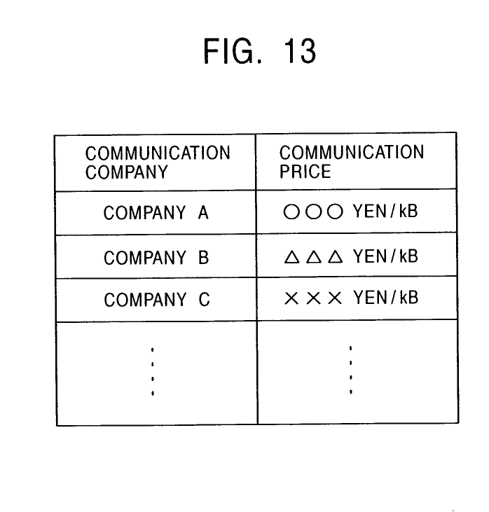

FIG. 13 illustrates typical data stored in the communication-price database 22 in a case where the communication fee is calculated according to the data amount. When a packet switching data communication service is adopted, data is divided for each packet having a predetermined length for transmission and/or reception. The drawing illustrates typical communication prices in a case where the communication fee is calculated according to the amount of data for transmission/reception. For example, the communication price per kilobyte from company A is shown as ◯◯◯ yen/kB, the communication price per kilobyte from company B is shown as ΔΔΔ yen/kB, and the communication price per kilobyte from company C is shown as ××× yen/kB. Such data is stored in the communication-price database 22. By reading the communication price for the communication company which is used by a user, from the communication-price database 22, and by multiplying the communication price by the data amount of information that had been transmitted to the user, the user can calculate the communication fee which he/she pays to the communication company. Thus, in the case where the communication fee is determined according to the amount of the information which was actually transmitted and received, instead of the communication time, the communication fee is calculated according to the amount of the data which was provided according to the service selected by the user. Thus, the amount of the total fee which is charged for receiving the service can be clearly understood and controlled.

In the above-described embodiment, the communication fee for each of the users is calculated by the charging-information generation-and-update unit 72 based on the communication prices shown in FIG. 5 and the actual communication time. However, the users may retrieve data of the communication fees which are charged to the users from the communication companies.

However, the communication companies may set various kinds of charging systems other than those shown in FIG. 5. According to one of such charging systems, for example, a fixed fee may be charged to a user if the user receives service within a predetermined time (10 hours for example), and an extra fee may be charged to the user according to a predetermined communication price (◯◯ yen/minute for example) when the user communicates over the predetermined time. In such a case, the communication fee charged to the user should be calculated in consideration of the above-described charging method.

As has been described in the above-described embodiment, FIG. 9 shows the horizontal axis corresponding to the number of days, the vertical axis corresponding to the total fee, and line A corresponding to the maximum value of charging. If a point indicating the total fee is shown under line A, the charging status is determined as admissible. Further, in the above-described embodiment, the charging status is determined based on the total fee as a percentage of the maximum value and the number of days that passed within the predetermined period and are subjected to charging. However, such a method for determining the charging status can be modified in various ways.

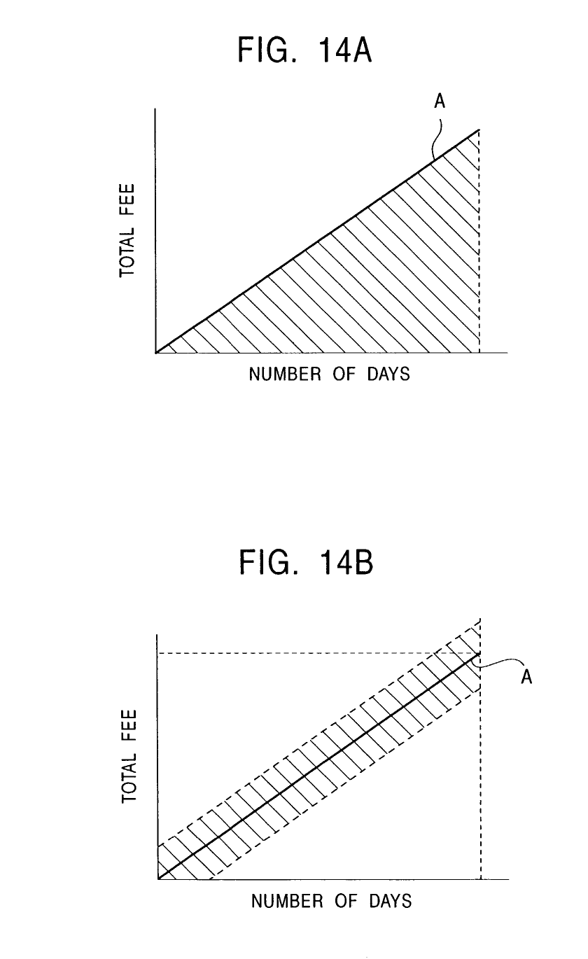

Each of FIGS. 14A and 14B illustrates a modified method for determining the charging status. As in FIG. 9, each drawing shows a horizontal axis corresponding to the number of days, a vertical axis corresponding to the total fee, and line A corresponding to the maximum value of charging. In each of the drawings, a hatched area is shown (hereinafter referred to as an admissible area). If the total fee is within the hatched area, the charging status is determined as admissible.

In a case shown in FIG. 14A, if a point indicating the current total fee is shown under line A, the charging status is determined as admissible, as in the above-described embodiment. However, the charging status for a user may be determined irrespective of the total fee as a percentage of the maximum value and the number of days that passed within a predetermined period and are subjected to charging. When the point which indicates the current total fee is shown above the admissible area, the data amount of map information for distribution may be limited. In this case, by simply determining whether or not the point which indicates the current total fee is shown above the admissible area, the charging status can be determined. Accordingly, determining the charging status is simplified.

In a case shown by FIG. 14B, if the total fee is 10% more or less than an expected total fee indicated by line A, the charging status is determined as admissible. The hatched area, that is, the admissible area is provided for showing the admissible amount of the total fee. If a point indicating the current total fee is shown above the admissible area, the data amount is limited. However, if the point is shown under the admissible area, the limitation of the data amount is relaxed or the data amount is increased. Thus, it becomes possible to clearly determine whether or not the current charging status is admissible within a predetermined period that is subjected to charging. Further, it becomes possible to control the charging so that the point indicating the current total fee is shown near line A. Such a modification protects the user from receiving too much service in the first half of the charged period. If the user had received too much service, the amount of the fee charged to the user would reach the maximum value and the user would not be able to receive service in the latter half of the charged period. Thus, according to the modification, the user can constantly receive service over the predetermined charged period.

In the above-described embodiment, a service for distributing map information is provided to the user. However, since the present invention can be used for distributing various kinds of content to a user, the content for distribution may not be limited to map information. Further, the user can receive content without using the navigation apparatus. That is to say, the present invention can be used in a case where the user communicates with the Internet using an information terminal such as a home personal computer or a mobile phone that can communicate with the Internet for receiving various types of content distribution service.

1. A service provider for providing information to a user over a communication link at a charge according to the service provided, comprising:
a maximum-value storing unit for storing information about a maximum value of charging for each user; and
a service-providing unit for modifying the details of information for distribution based on the maximum-value information and for distributing the information to the user.

2. A service provider according to claim 1, wherein the maximum-value information is set by the user.

3. A service provider according to claim 1, further comprising a service-plan generating unit for generating a service plan so that the details of the information for distribution can be modified based on the maximum-value information, wherein the service-providing unit provides the service according to the service plan.

4. A service provider according to claim 3, wherein a plurality of candidate service plans are available whose details are different from one another, and the service-plan generating unit selects one of the candidate plans according to the maximum-value information for the user.

5. A service provider according to claim 3, wherein the service-providing unit selects the type of information to be distributed by the service based on the service plan.

6. A service provider according to claim 3, wherein the information to be distributed is map information for a navigation apparatus.

7. A service provider according to claim 1, wherein the service-providing unit selects the type of information to be distributed by the service based on the maximum-value information.

8. A service provider according to claim 1, wherein the service-providing unit obtains current charging information for the provided service, determines whether or not the status of charging for the provided service is appropriate, and modifies the details of the service to be provided in accordance with the determination.

9. A service provider according to claim 8, wherein the service-providing unit sets an admissible limit for charging in consideration of the maximum-value information and a period subject to the charging, determines charging status as inappropriate when charging is requested over the admissible limit, and modifies the details of the service to be provided.

10. A service provider according to claim 8, wherein the charging is performed in a predetermined period, and the service-providing unit modifies the details of the service to be provided in consideration of the amount of time that has passed in the predetermined period which is subject to the charging.

11. A service provider according to claim 8, further comprising a charging-information generation-and-update unit that generates the charging information for the user, monitors the status of the service provided by the service-providing unit, and updates the charging information.

12. A service provider according to claim 8, further comprising a notification unit that determines whether or not the charging for the provided service exceeds a reference value that is set according to the maximum-value information which is generated by the charging-information generation-and-update unit, and when the charging exceeds the reference value, the notification unit transmits a notification to the user that the charging exceeds the reference value.

13. A service provider according to claim 12, wherein the service-providing unit continues providing the service when the user agrees to pay more than the maximum value upon receiving the notification, which is transmitted from the notification unit, and stops providing the service when the user does not agree to pay more than the maximum value.

14. A service provider according to claim 1, wherein the charging includes a first fee for the provided service and a second fee for communications performed for the provided service.

15. A service provider according to claim 14, wherein the first fee is changeable and the second fee is a fixed fee.

16. A service provider according to claim 14, wherein the first fee is a fixed fee and the second fee is changeable.

17. A service provider according to claim 14, wherein the second fee is determined according to the amount of the information provided by the service for which the first fee is charged.

18. A method of operating a service provider for providing information to a user over a communication link at a charge according to the service provided, comprising:
storing information representing a maximum value of charging for each user;
controlling the distribution of information to a user based on the maximum-value information associated with the user.

19. A method according to claim 18, wherein the distribution of information to a user is conducted according to a predetermined service plan associated with the user if current charging information for the provided service does not exceed a predetermined threshold that is related to the maximum value of charging for the user, and is modified if said current charging information exceeds said predetermined threshold.

20. A method according to claim 19, wherein at least one of the amount and the types of information distributed to the user is reduced if said current charging information exceeds said predetermined threshold.

21. A method according to claim 20, wherein said predetermined threshold also is based on the amount of time that has passed in the current charging period.

22. A method according to claim 21, further comprising:
notifying the user if said current charging information exceeds said predetermined threshold.

23. A method according to claim 21, wherein the charge to a user includes a first fee for the provided service and a second fee for communications performed for the provided service, and at least one of the first and second fees is changeable.

24. A method according to claim 23, wherein the second fee is changeable in accordance with the amount of information provided by the service for which the first fee is charged.
